(19) United States
(12) Patent Application Publication
(10) Pub. No.: US 2004/0151378 A1
(43) Pub. Date: Aug. 5, 2004

(54) Method and device for finding and recognizing objects by shape

(76) Inventor: Richard Ernest Williams, Lake Mary, FL (US)

Correspondence Address: Williams Family Trust A, Richard E. William, Trustee, 3715 Wimbledon Drive, Lake Mary, FL, 32746, US

(21) Appl. No.: 10/356,091

(22) Filed: Feb. 3, 2003

(51) Int. Cl. G06K 9/48

(52) U.S. Cl. 382/199

(57) ABSTRACT

An image of arbitrary size, location, or orientation in a relatively large planar field of view is quickly recognized by mathematically deriving an abstract ‘K-factor’ from counts of edge and area intercepts. A cluster of pixels first quickly searches for the image. When a candidate is found, the cluster closely scrutinizes an associated region, and derives the K-factor. The factor relates to shape, but is invariant to location, orientation, or size. It is then compared, with ancillary size data if desired, to counterpart library references. A best match is alphanumerically displayed, identifying the image. The invention can locate and identify contraband concealed under clothing without compromising individual privacy.

### TECHNICAL FIELD

This invention relates generally to pattern recognition and more specifically to a method and device for finding an object and generating an associated shape function.

### BACKGROUND ART

Optical character recognition machines and similar devices require very restricted angles of approach to a character in the plane. The human eye has similar limitations, but is far better able to quickly find and identify objects. Attempts to devise a machine capable of finding and identifying in a manner invariant to area, orientation, or location in a planar field of view have been generally unsuccessful. A major problem relates to the ‘symmetric order’ of an image. A circle, for example, has perfect symmetry because it can be rotated through any angle without changing its pattern. Most images do not have that property. Changes in orientation, size, or position affect their pattern signatures when expressed as a set of coordinate points.

### SUMMARY OF THE INVENTION

The present invention simulates important features of human visual perception. It quickly finds an object and generates a dimensionless factor, here called a ‘K-factor’, that closely relates to the object shape. A K-factor is invariant to size, orientation, and location of the object in a field of view. Factors are particularly useful for rapidly providing identifications of weapons such as firearms, box cutters, explosives, etc., that have been concealed behind clothing. Individual privacy is preserved because all information is displayed in alphanumeric form. A shape factor can be controllably combined with an area measure for maximum flexibility and effectiveness.

Accordingly, it is an object of this invention to provide a novel method of recognizing an object in a manner controllably invariant to size, orientation, or location in a field of view.

Another object of this invention is to provide a novel device for recognizing an object arbitrarily oriented and located in a field of view, and providing its identification in alphanumeric form.

Still another object of this invention is to provide a device and method that recognizes images and controllably senses their sizes.

Yet another object of this invention is to provide a device and method for rapidly finding and identifying an object located in a much larger field of view.

### BRIEF DESCRIPTION OF DRAWINGS

These and other objects of the invention will become apparent when taken in conjunction with the drawings wherein:

FIG. 1 is a basic block diagram of a preferred embodiment of the present invention for finding and recognizing an object of arbitrary size, randomly oriented and located in a field of view;

FIG. 2 is a depiction of a disk's perfect symmetry;

FIG. 3 is a representation of a firearm showing a relationship between orientation and scan direction;

FIG. 4 is a simplified depiction of cone and rod deployment in a human eye retina;

FIG. 5 is a representation of a canonical cluster of root pels (pixels) employed in the invention;

FIG. 6 is a representation of an image edge being scanned by the cluster of FIG. 2;

FIG. 7 is a representation of a typical object located in an entire field of view.

FIG. 8 depicts the manner in which an image is scrutinized in the invention; and

FIG. 9 indicates the effect of changed location and orientation upon the image of FIG. 8.

### DETAILED DECRIPTION OF PREFERRED EMBODIMENTS OF THE INVENTION

Broadly speaking, the present invention provides a search and scrutiny sequence similar to that employed in human visual processes. It is able to rapidly find and identify an arbitrarily oriented object in a relatively large field of view. When used in conjunction with X-ray or long wavelength infrared detection methods, its alphanumeric display allows it to identify a contraband image through clothing without violating an individual's privacy.

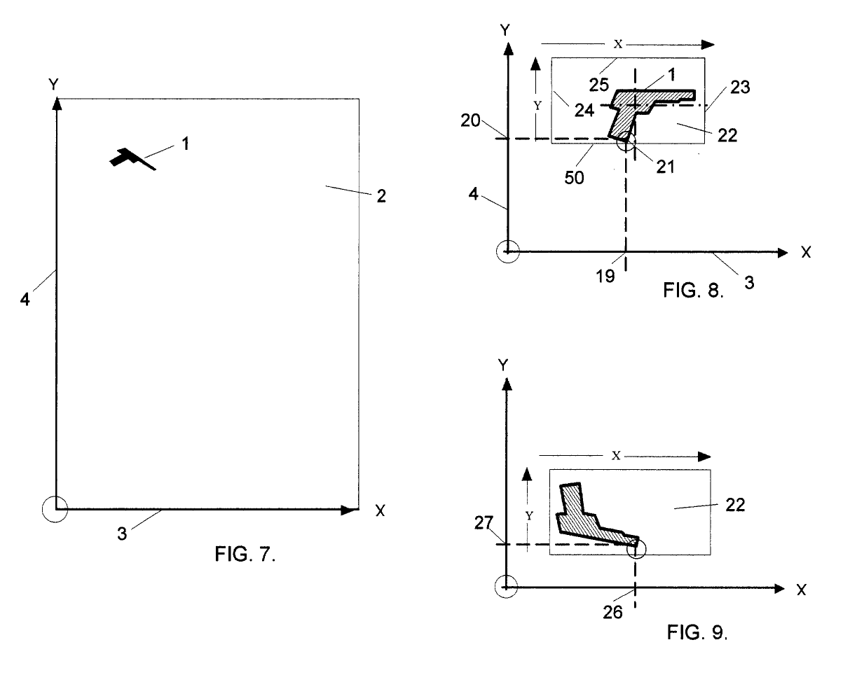

Turning now more specifically to the drawings, FIG. 7 depicts a typical application. An object of interest 1, which is shown as a firearm, is located at an arbitrary orientation in a relatively large field of view 2. For expository purposes the field will be considered comprised of numerous picture elements, or pels (formerly “pixels”), whose individual locations are expressed by Cartesian coordinates 3 and 4. The invention is required to quickly locate and identify the firearm.

Each pel will normally exhibit various attributes such as gray scale, color, selective spectral responses, etc. For descriptive clarity hereafter, any image such as the firearm will be assumed to produce merely a black image upon a white background. “Black” is accordingly defined here as a state above a selected attribute level, and “white” as a state below that level.

A human eye focuses a field of view, about a hemisphere, onto the eye's retina. Two types of light-sensitive neural sensors, cones and rods, are deployed about the retina in the manner of FIG. 4, which is highly simplified. Millions of sensors are actually involved. They can be dichotomized into a cluster of thousands of cones located at the center of vision, or fovea, 5, and a surrounding peripheral region containing all remaining sensors such as 6. The foveal cones 5 are densely packed and survey a solid angle of about two degrees at the center of the field of view. The fovea has high resolution and color sensitivity. The peripheral region contains a lower-density distribution of mostly rods of higher sensitivity 6. Rods have little color perception, but are very sensitive to image edges.

To find and identify an image, the human eye constantly scans (“nystagmus”) within its ball-and-socket joint. Normally, an image is first sensed by peripheral pels 6. The eye can accordingly immediately sense the approximate location of a change in activity. Depending upon cognitive instructions, the eye may move its foveal region 5 to a mathematical analog of the image's center of gravity to scrutinize the image. All pels move in concert as the eye scans. Distances between pels in the main are unequal, but hold constant.

The present invention emulates major aspects of the eye's search-and-scrutinize process. It reduces the distribution of FIG. 4 to a small canonical approximation in local planar Cartesian coordinates 12, 13 as shown in FIG. 5. Unlike the eye, the root pel array of a cluster is divided into equal coordinate intervals to simplify digitization. A center pel 7 substitutes for the foveal region 5 of FIG. 4. Closely surrounding root pels 8, 9, 10, and 11 emulate the inner peripheral region of FIG. 4. The quintet cluster of FIG. 5 is a preferred embodiment in the present invention. When FIG. 4 is compared to FIG. 5, however, it is evident that the foveal and peripheral regions can have other root-pel counts and distributions without changing the spirit or scope of the invention.

When scanning occurs, the entire cluster of FIG. 5 is stepped without changing the root pel array. FIG. 6 depicts a cluster scanning from right to left. If an object edge 14 is encountered, root pels 7, 8, and 11 sense black. Root pels 9 and 10 sense white. If the cluster of FIG. 6 had stepped sufficiently farther left or down, all root pels would have sensed black. That state would imply that the cluster is completely within an image. Farther right or up, all would become white. That state would be interpreted as background. In the present invention various combinations of root pel states are used to reveal image edges and interior or exterior positions.

A novel procedure in the invention leads to a very significant speed increase. Thousands of cluster readings are normally required in a field scan. A single root pelt, preferably center pel 7 of FIG. 5, is designated as a location pointer for the cluster. The cluster root-pel generation and reading routine is arranged to always start with pel 7. If that pel reads white, the invention concludes that background is being sensed. It immediately bypasses any further processing at that location, and proceeds to a next scanning step. Since the number of background readings typically vastly exceeds that of image intercepts, a huge speed increase is obtained with a negligible affect upon performance.

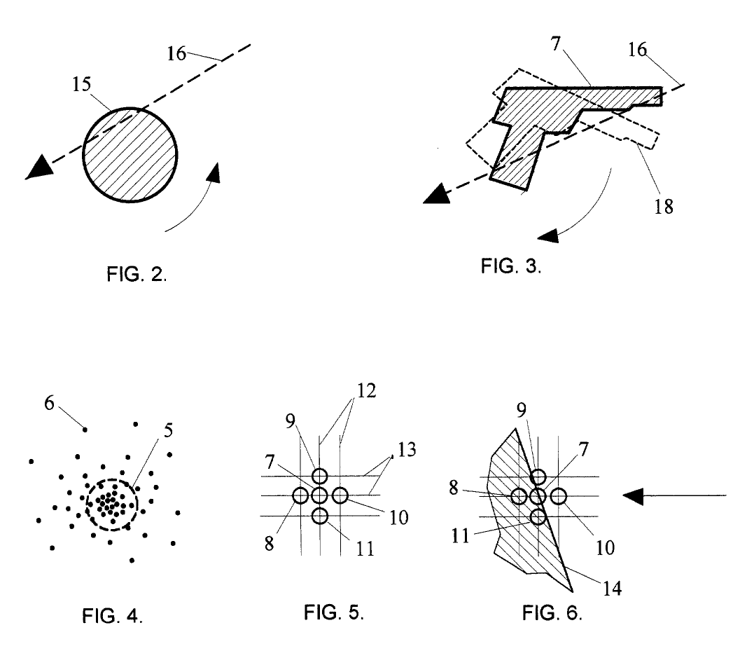

Unless accommodated, a serious problem involving symmetry order of an image remains. Referring to FIG. 2, a circle has ‘perfect symmetry’ in the plane. A rotation of disk 15 would have no effect upon an intercept pattern produced by a cluster scan along vector 16. That is not the case with most images. Firearm 17 of FIG. 3, for example, produces a very different intercept pattern than a rotated version 18. The present invention finds and recognizes a firearm regardless of its orientation in the plane.

Two major routines are provided. The first searches for an image in a manner that allows a thorough scrutiny routine to follow. The second scrutinizes, overcomes the symmetry problem, and provides recognition.

Referring now to FIG. 8, the invention's search process is as follows;

1. For scanning purposes the pel cluster of FIG. 5 is first treated as a single large pel. Its effective diameter is approximately three times that of a root pel. Each scan step can therefore encompass three root-pel intervals 12 of FIG. 5. An entire raster is scanned nine times faster.

2. A raster scan employing a rapid sweep along X-coordinate 3 of FIG. 8 and a slower sweep along Y-coordinate 4, intercepts firearm 1 at an interception point 21. The point is typically at a lowest Y-coordinate image extent, and is detected by a predetermined number of black states in root pels of FIG. 5 or FIG. 6.

3. The location of a scrutiny box 22 of FIG. 8 is referenced to intercept coordinates 19, 20. When an intercept has occurred, sweeping is stopped and coordinates 19, 20 stored. Lower box boundary 50 is slightly reduced below Y-coordinate 20 to assure that the image bottom edge is completely within box 22. Upper box boundary 25 is defined by adding a predetermined expected-maximum image dimension to Y-coordinate 20.

X-coordinate sides 23, 24 of the box are defined by adding and subtracting the same predetermined dimension to and from X-coordinate 19. Box 22 width is then approximately twice its height.

Referring to FIG. 9, if the firearm is shifted in location, flipped, and reoriented, the described procedure assures that it will remain totally within its scrutiny box 22. The invention can display the approximate location of the firearm within the entire field of view 2 of FIG. 7 if desired. Coordinates 19, 20 of FIG. 8 or coordinates 26, 27 of FIG. 9 provide that data.

Rapid sweeps of the search routine are stopped when a scrutiny box has been generated. The invention then shifts to a scrutiny procedure whose actions are applied within box 22. In typical applications the viewing area corresponding to box 22 is in the order of one tenth the area of an entire field of view 2 of FIG. 7. Within the box each scan step is reduced to a single array-grid step having a distance corresponding to a grid interval 12 or 13 of FIG. 5. Although more steps than in the search phase are required to move a predetermined distance, less area coverage is required by the scrutiny box.

The cluster of FIG. 5 is very small relative to a typical image area. The orientation problem described with reference to FIGS. 2 and 3 is accommodated in a novel way as follows:

1. A function of image area is obtained by counting scan steps in which more than a predetermined number of black root pels appear.

2. A function of image-edge length is obtained by counting scan steps in which the number of black root-pels falls within a predetermined range and the number of white root-pels simultaneously falls within a second predetermined range.

3. The edge function is squared, and divided by the area function. Alternatively, an algorithm can divide the edge count by the square root of area to yield a square-root quotient. In either event, the quotient is a dimensionless shape number, and is hereafter called a “K-factor” due to its invariant properties. The cruciform symmetry of the cluster of FIG. 5 assures that the K-factor is substantially invariant to planar orientations such as rotations.

4. When applied to the perfect symmetry case of FIG. 2, a theoretical K-factor equals 12.57. For a square shape, it is 16. A firearm such as that of FIG. 8 experimentally and theoretically produces a K-factor of about 40.

5. It can be shown that a K-factor is a strong indicator of shape. It is always dimensionless, and invariant to location, size, and orientation. It is not completely exclusive, however. Matching quotients can infrequently arise despite shape differences. Such occurrences can almost always be removed by employing the already-available area count as an additional cue.

A scrutiny routine accordingly directly results in two powerful parameters for recognition, K-factor and area. A “train” configuration of the invention allows an operator to place both into a non-volatile memory for future comparison to unknown images. An additional weighting coefficient can also be placed into memory by the operator. It essentially weights the relative importance of area to K-factor on the basis of experimental data. In most cases area can be completely disregarded. In others it may be very significant. That is also an important observed feature of human visual perception. The invention provides such flexibility.

Other data such as an identification label can be stored at a trained image address. All data plus location information can be displayed by the present invention.

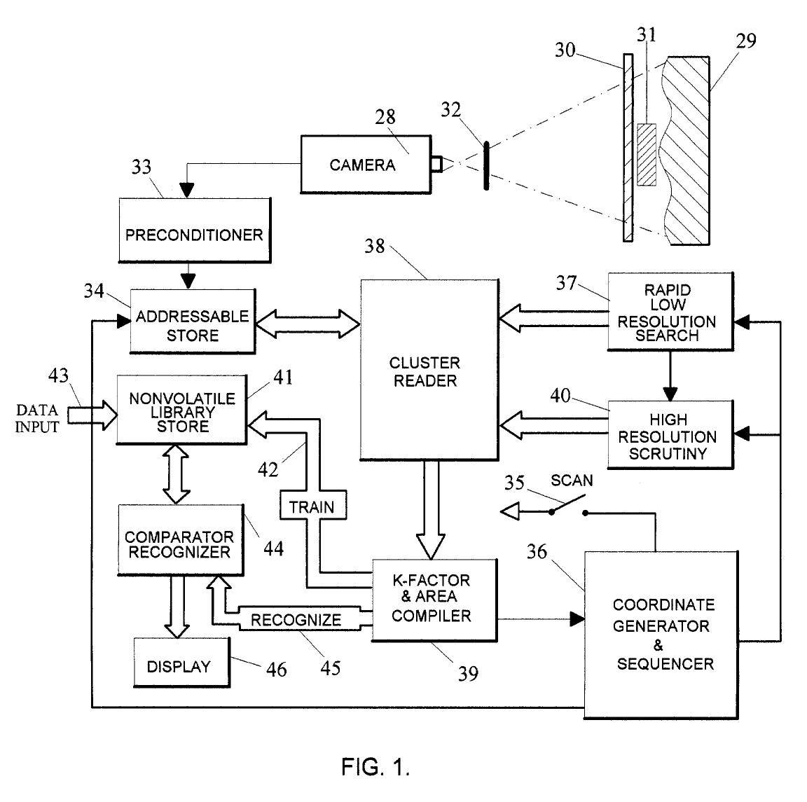

The above described functions are implemented in the invention as shown in FIG. 1. For exposition, an input is assumed to be an infrared camera 28 intended to find contraband behind clothing. In that application the radiant energy source 29 is a human body. When observed visually, a layer of clothing 30 may conceal a contraband object 31. Body 29 radiates infrared at wavelengths ranging from about two to fifteen microns. Camera 28 is able to detect a selected portion of that radiation through a matched spectral filter 32. Its spectrum is chosen to match expected image absorption spectra, and to obtain maximum image contrast. Object 31 absorbs the radiation spectrum selected by filter 32 and creates a silhouette-like image for camera 28. If the image were then displayed, body 29 would also be displayed. Privacy would be violated. Reducing the display to alphanumeric form completely overcomes the problem.

Camera 28 produces an electrical planar pattern. Such cameras are widely used. They are not considered novel to the invention. A candidate may be a television camera producing a series of images. It may also be a digital camera in which a single frame is generated. In any event its output is passed through preconditioner 33 which is an optimal electrical filter. The filter's function is to reduce most interference by imposing bandwidth and other limitations. No novelty is claimed here for preconditioner 33. Depending upon the application, the number of pixels in the electrical planar pattern may range from thousands to millions.

The electrical pattern is then passed to addressable store 34. The function of store 34 is to provide pixel addresses suited to the invention. Typically store 34 is a random-access memory (RAM) where image pixels are stored at discrete addresses. The field need not be well-ordered physically. Adjacent pixels do not have to occupy adjacent physical locations in the RAM. It must, however have a well-ordered isomorphic (one-to-one) correspondence between each address and the location of an originating pixel. In the invention, increments or decrements in coordinate addresses correspond to similar shifts in input pixel locations.

An image recognition is triggered by an operator-controlled switch 35 in FIG. 1. The switch activates store 34 to capture an input image. Typically thousands of input pixels are very rapidly written into store 34. Less than a few milliseconds are normally required for a complete transfer. Immediately following the transfer, coordinate sequencer 36 starts a rapid low-resolution search generator 37. A search as described in detail above with reference to FIGS. 7, 8, and 9 is performed.

The cluster of root pels of FIG. 5 are then read by cluster reader 38 of FIG. 1. Each root pel is sequentially sampled at very high speed. Cluster reader 38 is at the heart of the invention, and is used many thousands of times during a recognition. Coordinates such as 19, 20 of FIG. 8 are generated by sequencer 36 and low-resolution search 37 as they scan store 34 of FIG. 1. Assume that an image is intercepted. One of the cluster's root pels, usually center pel 7 of FIG. 5, is located at coordinates 19, 20 of FIG. 8. Before coordinates 19, 20 move on, pel 7 and possibly other root pels are sampled. If a sufficient number of root pels are black around that location, they are detected by reader 38 and compiler 39. The sweeps are then stopped at coordinates 19 and 20. If the number of black pels is insufficient, search sweeps are continued.

Cluster reader 38 does not have to generate entire RAM addresses but, as seen in FIG. 5, need only increment or decrement addresses already generated by search 37. Accordingly, reader 38 and compiler 39 can operate very rapidly. Their quintet of reads are forwarded to sequencer 36 for sweep-stop or other decisions.

When a search has found an image candidate, sequencer 36 switches control to high-resolution scrutiny 40. As described above with reference to FIGS. 7, 8, and 9, scrutiny 40 generates a high-resolution scanning sequence in a scrutiny box surrounding the coordinate points created by search 37. Cluster reader 38 and compiler 39 again compile information upon root-pel states. K-factors and areas are independently compiled. If the operator of the invention is training it on an image, data of compiler 39 are forwarded on bus 42 to library store 41. The stored data are then available for downloading to field units when recognition is required. If desired, input data bus 43 can be used to append to a library location a weighting coefficient that optimizes the relative influences of area and K-factor. The operator can also use bus 43 to attach a label to stored image data. For example, “firearm” could be the label for the image of FIG. 7.

In a recognize mode, compiler 39 directly forwards the K-factor, area data of an intercepted image, and location data if desired, to recognizer 44 by bus 45. Recognizer 44 sequentially extracts stored K-factor and area combinations from library 41, and finds their ratios to current counterparts from reader 38. Unity ratios signify best matches. K-factor ratios and area ratios are then combined to provide overall measures of match: A weighting coefficient from library 41 can be invoked to affect a measure if the coefficient were stored at time of train. A label associated with a best library match is displayed by alphanumeric display 46 to categorize an intercepted image. If no adequate match is found during a complete scan, an appropriate message such as “no match” can be displayed.

While the invention has been particularly shown and described with reference to preferred embodiments thereof, it will be understood by those skilled in the art that various changes in forms and details may be made therein without departing from the spirit and scope of the invention.

I claim:

1. A method for selectively signifying the shape in a planar field of an image having an arbitrary location, size, or orientation, comprising the steps of
scanning said image to separately count edge intercepts and area intercepts;
mathematically squaring said count of edge intercepts and then dividing by said count of area intercepts to produce a function of said shape; and
signifying said shape by the value of said function.

2. A method for recognizing an object which has an arbitrary location, size, or orientation within a relatively large field of view, comprising the steps of:
transferring said field of view and an image of said object into a planar addressable-storage field;
generating a root-pel cluster having pels that produce first signal levels responsive to an image in said field, and second signal levels otherwise;
generating a search routine by stepping said cluster throughout said field;
incrementing an area count whenever the number of first signal levels in said cluster exceeds a predetermined value;
incrementing an edge count whenever the number of first signal levels in said cluster falls within a first predetermined range, and the number of second signal levels in said cluster falls within a second predetermined range;
combining said area count and said edge count in a computing algorithm that produces a dimensionless K-factor;
finding a degree of match between the K-factor of an intercepted image and a trained K-factor stored in a library; and
identifying said intercepted image by displaying a label attached to a library best match.

3. The method set forth in claim 2 in which said algorithm squares said edge count, and divides that squared count by said area count to produce said K-factor.

4. The method set forth in claim 2 in which said algorithm divides said edge count by the square root of said area count to produce said K-factor.

5. The method set forth in claim 2 in which the coordinate location of a first area count intercepted in said field by said cluster signifies the location of said object in said field.

6. The method set forth in claim 2 in which said area count is combined with said K-factor, and the combination is matched to counterparts stored in said library.

7. The method set forth in claim 5 in which a ratio between said area count and said K-factor is set by a weighting coefficient appended to said library.

8. A device for selectively signifying the shape in a planar field of an image having an arbitrary location, size, or orientation, comprising:
sweeping means for scanning said image;
detection and counting means for separately counting edge intercepts and area intercepts;
computing means for squaring the count of said edge intercepts and then dividing by the count of said area intercepts to produce a function of said shape; and
comparison means for signifying said shape by the value of said function.

9. A device for recognizing objects which have arbitrary locations, sizes, or orientations within a relatively large field of view, comprising:
transfer means to place said field of view with an image of said object into a planar addressable-storage field;
a pel responsive to an attribute of said image in said storage field, and having a first state if said attribute is above a predetermined level, and a second state otherwise;
cluster generating means to assemble a cluster of said pels;
sweep generating means for stepping said cluster throughout said storage field;
first counting means for incrementing an area count whenever the number of pels in said first state in said cluster exceeds a predetermined value;
second counting means for incrementing an edge count whenever the number of pels in said first-state in said cluster falls within a first predetermined numerical range, and the number of pels in said second-state in said cluster falls within a second predetermined numerical range;
computing means for combining said area and edge counts to produce a dimensionless K-factor;
comparator means for finding a degree of match between said K-factor of the intercepted image and a trained K-factor stored in a library; and
display means for identifying said image by displaying a label attached to a library best match.

10. A device as set forth in claim 9 in which said computing means includes means to mathematically square said edge count and divide that squared count by said area count to produce said K-factor.

11. A device as set forth in claim 9 in which said computing means includes means to divide said edge count by the square root of said area count to produce said K-factor.

12. A device as set forth in claim 9 further including display means in which the location of said object is expressed by the coordinate location of a first area count intercepted in said field by said cluster in said field.

13. A device as set forth in claim 9 in which said cluster of pels is distributed in a substantially cruciform array.

14. A device as set forth in claim 9 in which said area count is combined with said K-factor, and the combination is matched to counterparts stored in said library.

15. A device as set forth in claim 14 in which a ratio between said area count and said K-factor is set by a weighting coefficient appended to said library.
